(19) United States
(12) Patent Application Publication
(10) Pub. No.: US 2011/0298347 A1
(43) Pub. Date: Dec. 8, 2011

(54) DISTRIBUTION CABINET

(75) Inventors: Oliver Birkenstock, Berlin (DE); Philipp Meyer, Berlin (DE); Jiri Pasek, Brno (CZ)

(73) Assignee: ADC GmbH, Berlin (DE)

(21) Appl. No.: 13/151,804

(22) Filed: Jun. 2, 2011

(30) Foreign Application Priority Data
Jun. 2, 2010 (DE) 10 2010 022 451.0

(51) Int. Cl. H02B 1/38

(52) U.S. Cl. 312/295

(57) ABSTRACT

The invention relates to a distribution cabinet (1), in particular for accommodating telecommunications and data technology components, with the distribution cabinet (1) having at least one door, wherein the distribution cabinet (1) has at least a first door (21) and a second door (22), with the first door (21) covering a first subregion (11) of the distribution cabinet (1) and the second door (22) having a first part (31) and a second part (32), with the first part (31) at least partially covering the first door (12) of the distribution cabinet (1).

This application claims benefit of Serial No. 10 2010 022 451.0, filed 2 Jun. 2010 in Germany and which application is incorporated herein by reference. To the extent appropriate, a claim of priority is made to the above disclosed application.

### BACKGROUND

The invention relates to a distribution cabinet, in particular for accommodating telecommunications and data technology components, with the distribution cabinet having at least one door.

Distribution cabinets of this kind are constructed, for example, as outdoor cabinets. In this case, the cabinets have to be sufficiently well protected against vandalism and other external influences such as moisture. It is also known to design the side walls, rear wall and door to be of double-walled design so that heat can be dissipated by air flow within the double walls.

### SUMMARY

The invention is based on the technical problem of providing an operationally reliable distribution cabinet.

To this end, the distribution cabinet has at least a first door and a second door, with the first door covering a first subregion of the distribution cabinet and the second door having a first part and a second part, with the first part at least partially covering the first door and the second part covering at least a second subregion of the distribution cabinet. It should be noted here that the first subregion and the second subregion are not congruent. It should also be noted that “cover” relates to the closed state of the doors. Furthermore, the second door preferably closes the distribution cabinet completely.

As a result, work can be carried out in the second subregion of the distribution cabinet with the first door closed by opening the second door, with the first subregion still being protected by the first door. Depending on the design of the first door (first door which can be closed), the first subregion can be protected against access or, however, only against external influences such as driving rain. In this case, the first door is only closed but can be opened. For example, water-sensitive active electronics such as DSLAMs or XDSL technology can be arranged in the first subregion, these electronics then still being protected against rain while work is performed in the second subregion.

In one embodiment, the first door is of n-walled, preferably single-walled, design, and the second part of the second door is of x-walled, preferably double-walled, design and the first part of the second door is of (x-n)-walled design. This results in a complete x-walled door when both doors are in the closed state. In particular, the embodiment where n=1 and x=2 results in a very compact physical form which simultaneously exhibits all the advantages of a double-walled door in respect of heat dissipation.

The first part of the second door preferably completely covers the first door.

In one embodiment, the first door and the second door are connected in an articulated manner to the same side of the distribution cabinet.

In a further embodiment, a wall element which separates the first and second subregions is arranged in the distribution cabinet. The first door, together with the wall element and the other wall elements (side wall, rear wall and roof module), then preferably closes the first subregion completely and preferably hermetically in a moisture-tight manner.

The distribution cabinet preferably comprises metal or metallized plastic.

### BRIEF DESCRIPTION OF THE DRAWINGS

The invention will be explained in greater detail below with reference to a preferred exemplary embodiment. In the figures:

FIG. 1 shows a distribution cabinet with the first door open and the second door open, and

FIG. 2 shows the distribution cabinet with the first door closed and the second door open.

### DETAILED DESCRIPTION

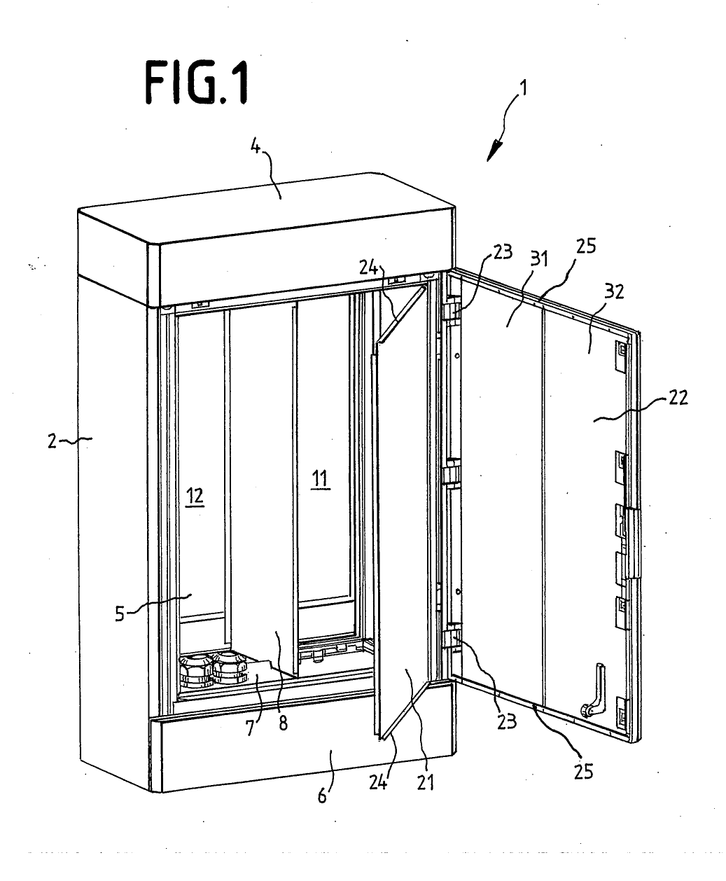

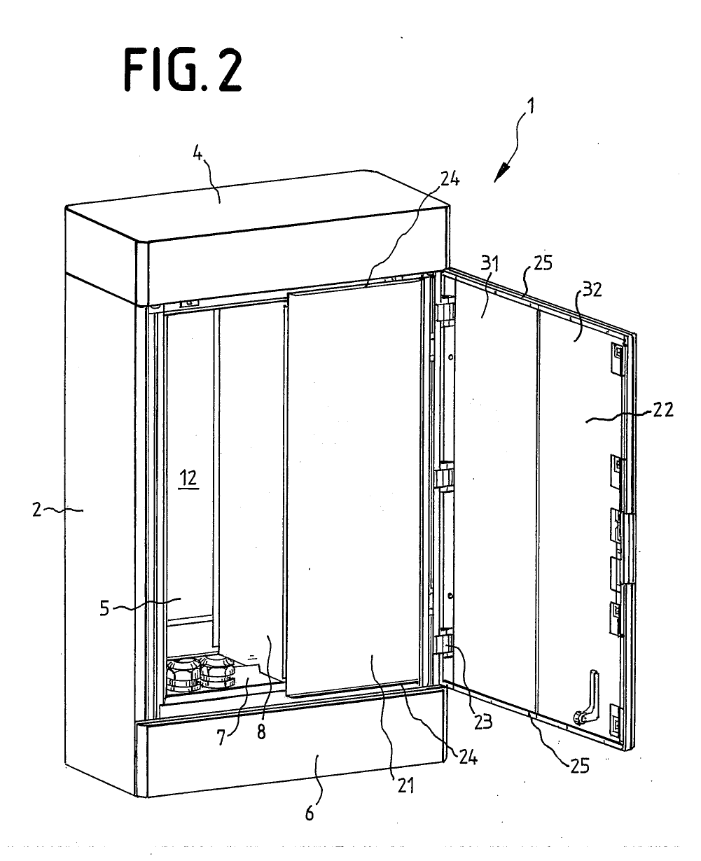

The distribution cabinet 1 according to FIGS. 1 and 2 comprises two side walls 2, a roof module 4, a rear wall 5, a base 6, a base plate 7 and a wall element 8. In this case, the wall element 8 divides the interior of the distribution cabinet 1 into a first subregion 11 and a second subregion 12. A first door 21 and a second door 22 are connected in an articulated manner in the region of the right-hand side wall 2 such that they can pivot. This is preferably performed by means of hinges 23. The second door 22 has a first part 31 and a second part 32. In this case, the first part 31 of the second door 22 completely covers the first door. That is to say, the first door 21 can be pivoted into the second door 22 and, when the second door 22 is closed, the first door 21 enters said second door completely; this will be explained in further detail later.

The first door 21 is of single-walled design. The first part 31 of the second door is likewise of single-walled design, whereas the second part 32 is of double-walled design. The first door 21 has edges 24 which project further forward. The second door 22 has edges 25 which project inward.

If the first door 21 is now closed and the second door 22 remains open (see FIG. 2), the first subregion 11 of the distribution cabinet 1 is closed and protected (for example against rain, in particular driving rain) by the first door 21 and the wall element 8, whereas the second subregion 12 is still accessible.

If the second door 22 is now closed as well, the edges 24 of the first door 21 slide under the edges 25 of the second door 22 in the region of the first part 31 of the second door 22. The first part 31 of the second door 22 and the first door 21 then together form a double-walled door section, and therefore, together with the second part 32 which is of double-walled design in any case, the whole door which is formed in the closed state is of completely double-walled design. Air can then circulate in this whole double-walled door via ventilation slots (not illustrated).

This door arrangement has all the advantages of a conventional double-walled door in respect of air circulation, weight and compactness, but can simultaneously protect the first subregion separately.

### LIST OF REFERENCE SYMBOLS

1 Distribution cabinet

2 Side walls

4 Roof module

5 Rear wall

6 Base

7 Base plate

8 Wall element

11 First subregion

12 Second subregion

21 First door

22 Second door

23 Hinges

24 Edges of the first door

25 Edges of the second door

31 First part

32 Second part

1. A distribution cabinet, for accommodating telecommunications and data technology components, with the distribution cabinet having at least one door, wherein the distribution cabinet has at least a first door and a second door, with the first door covering a first subregion of the distribution cabinet and the second door having a first part and a second part, with the first part at least partially covering the first door of the distribution cabinet.

2. The distribution cabinet as claimed in claim 1, wherein the first door is of n-walled design and the second part of the second door is of x-walled design and the first part of the second door is of (x-n)-walled design.

3. The distribution cabinet as claimed in claim 2, wherein the first door is of single-walled design and the second part of the second door is of double-walled design.

4. The distribution cabinet as claimed in claim 1, wherein the first part of the second door completely covers the first door.

5. The distribution cabinet as claimed in claim 1, wherein the first door and the second door are connected in an articulated manner to the same side of the distribution cabinet.

6. The distribution cabinet as claimed in claim 1, wherein a wall element which separates the first and second subregions is arranged in the distribution cabinet.

7. The distribution cabinet as claimed in claim 1, wherein the distribution cabinet is composed of metal.

8. A distribution cabinet comprising:
two side walls, a roof module, a rear wall, a base, and a base plate defining an interior;
a wall element, the wall element dividing the interior of the distribution cabinet into a first subregion and a second subregion; and
at least a first door and a second door, with the first door covering the first subregion and the second door having a first part and a second part, with the first part at least partially covering the first door.

9. The distribution cabinet as claimed in claim 8, wherein the first door is of n-walled design and the second part of the second door is of x-walled design and the first part of the second door is of (x-n)-walled design.

10. The distribution cabinet as claimed in claim 9, wherein the first door is of single-walled design and the second part of the second door is of double-walled design.

11. The distribution cabinet as claimed in claim 8, wherein the first part of the second door completely covers the first door.

12. The distribution cabinet as claimed in claim 8, wherein the first door and the second door are connected in an articulated manner to the same side of the distribution cabinet.

13. The distribution cabinet as claimed in claim 8, wherein the distribution cabinet is composed of metal.
